(19) United States
(12) Patent Application Publication
(10) Pub. No.: US 2007/0115552 A1
(43) Pub. Date: May 24, 2007

(54) Polarization beam splitter and combiner

(75) Inventors: Michael G. Robinson, Boulder, CO (US); Jianmin Chen, Superior, CO (US)

Correspondence Address: BAKER & MCKENZIE LLP;PATENT DEPARTMENT, 2001 ROSS AVENUE, SUITE 2300, DALLAS, TX, 75201, US

(73) Assignee: ColorLink, Inc., Boulder, CO (US)

(21) Appl. No.: 11/468,586

(22) Filed: Aug. 30, 2006

Related U.S. Application Data
(60) Provisional application No. 60/596,157, filed on Sep. 2, 2005.
(60) Provisional application No. 60/717,134, filed on Sep. 14, 2005.

(51) Int. Cl. G02B 27/28; G02B 5/30

(52) U.S. Cl. 359/495

(57) ABSTRACT

A polarization beam splitter (PBS) and combiner includes a multilayer birefringent stack adjacent to a dichroic coating, sandwiched between glass prisms. This configuration overcomes the reflected wave distortion associated with a conventional multilayer birefringent cube PBS while maintaining excellent polarization performance. An exemplary application of the PBS and combiner is in a four-port LCOS imaging system. LCOS projection architectures based on the PBS are also disclosed.

### CROSS-REFERENCES TO RELATED APPLICATIONS

This application claims priority to provisional patent application No. 60/596,157, entitled “A New Hybrid PBS for LCOS Projection,” filed Sep. 2, 2005. This application also claims priority to provisional patent application No. 60/717,134, entitled “Hybrid PBS for LCOS Projection,” filed Sep. 14, 2005.

### TECHNICAL FIELD

This application relates to a polarization beam splitter, and more in particular to a polarization beam splitter and combiner for projection systems.

### BACKGROUND

Polarization beam splitters (PBS) are optical components used in front and rear projection systems to split input light into two beams with opposite polarization states. PBSs have also been used to combine light from two ports for output through a single port. In some projection applications, PBSs have been used for both splitting and recombining light, for instance as provided in the ColorQuad™ and CQ3® architectures, by ColorLink, Inc., Boulder, Colo.; also described in commonly-assigned U.S. Pat. Nos. 6,183,091 and 6,961,179, which are herein incorporated by reference. Various PBSs are known, including multilayer birefringent cube PBSs, MacNeille-type PBSs, and wire-grid polarizer-type PBSs. More detail on these PBSs and related projection system architectures can be found at M. Robinson, J. Chen and G. Sharp, POLARIZATION ENGINEERING FOR LCD PROJECTION 97-98 (Wiley & Sons 2005) [hereinafter POLARIZATION ENGINEERING], which is hereby incorporated by reference for all purposes.

FIG. 1 illustrates an exemplary Multilayer Birefringent Cube (MBC) PBS 100. An MBC PBS 100 is typically made of multilayer birefringent stack 200 with alternating high/low refractive indices (i.e., from layers 208, 210). The multilayer birefringent stack 200 is sandwiched by two bulk glass prisms 102, 104. Glass prisms have typically been made from high-index glass, with high lead content, for example, PBH56 and SF57.

FIG. 2 shows the structure of a typical multilayer birefringent stack 200 which is made from a polarizing film. The multilayer birefringent stack 200 comprises alternate layers of different uniaxial birefringent materials, 208 and 210, with a common optic axis. In one direction, the refractive indices of the materials are matched, having refractive index n. In an orthogonal direction, in the plane of birefringent material, the refractive indices of birefringent materials 208 and 210 are n₂ and n₁ respectively. Because the structure of multilayer birefringent stack 200 appears homogeneous, light polarized along this direction (e.g., s-polarized light) is transmitted without loss. In the orthogonal direction, the structure is inhomogeneous, taking the form of a thin-film multilayer mirror (e.g., for the p-polarized light).

The polarizing film material that may be used in multilayer birefringent stack 200 may typically have between 100 and 800 layers of alternate polymers 208, 210. In a color specific embodiment discussed herein, the number of layers may be closer to 300. Made from thermally processed extruded multilayer polymer, the entire layered structure is stretched to form the necessary birefringence within the layers 208, 210. In this way the extraordinary index is controlled to achieve high reflectivity for one polarization, whereas the ordinary axis is matched yielding high transmission for the orthogonal polarization. The optic axes of all layers are substantially parallel to the stretch direction and can therefore be considered the optic axis of the composite film. Since the unaffected transmitted wave is orthogonal to this optic axis, the polarizer is effectively an o-type polarizer in transmission, but e-type in reflection.

Incorporating the multilayer birefringent reflecting polarizing material (multilayer birefringent stack) 200 of FIG. 2 between glass prisms produces a multilayer birefringent cube PBS 100, as shown in FIG. 1. With regard to the multilayer birefringent stack 200, the orientation of the optic axis defines the transmitting and reflecting polarizations, as for a conventional sheet polarizer. This in principle allows transmission of either s- or p-polarizations.

FIGS. 3A and 3B show two configurations and their respective optic axes. FIG. 3A is a schematic block diagram of an MBC PBS 300 that transmits p-polarized light 302 and reflects s-polarized light 304. In an alternative configuration, in which multilayer birefringent stack 200 is orthogonally arranged, FIG. 3B provides an MBC PBS 350 that transmits s-polarized light 304 and reflects p-polarized light 302. The configuration for MBC PBS 300 shown in FIG. 3A has been commercially developed by 3M, Inc. under the Vikuiti™ name.

There are various advantages to using an MBC PBS 100 over a MacNeille-type PBS. Such an MBC PBS 100 delivers good contrast and high transmission without the drawback of geometrical polarization axis rotation associated with conventional MacNeille cube PBSs.

A disadvantage, however, is its poor front wave distortion in the reflected channel due to poor flatness of the multilayer birefringent stack 200. This limitation is unfortunate, since it precludes the reflected image from being adequately conveyed in a projection system, thus preventing four ports of MBC PBS 100 from being used in an optical imaging system, for example, such as one using a ColorQuad™ or CQ3® architecture.

The schematic block diagram of modulation subsystem 400 in FIG. 4 illustrates the poor wave front distortion encountered with a conventional MBC PBS 100 and LC modulators 120, 122 for two different wavelength ranges. In this illustration, s-polarized light 130 reflects off multilayer birefringent stack 200 toward first LC panel 120. The first LC panel 120 modulates the light 130 and transmits p-polarized light 132 through multilayer birefringent stack 200 toward an output port. Input p-polarized light 134 is transmitted through the multilayer birefringent stack 200 toward a second LC panel 122. Light modulated by the second LC panel 122 is modulated and reflected back as s-polarized light 136 toward the multilayer birefringent stack 200. Due to the poor front wave distortion in the reflected channel, s-polarized light 138 provides an inferior quality reflected image. Accordingly, MBC PBS 100 is unsuitable for use in a four port modulation subsystem 400 that uses two LC modulating panels 120, 122.

Another performance concern with MBC PBS 100 relates to stress-induced birefringence in both the polymer layers 200 and the surrounding glass 102, 104. It is a concern because any intrinsic or induced birefringence alters the polarization state of light, causing non-uniform system performance characteristics, such as poor system contrast, and a non-uniform picture, among others.

Induced birefringence in the PBS can result from several conditions. The first is internal stress due to the forming of glass. Second, bonding and mounting glass components should be done carefully to avoid stress. Finally, thermally induced birefringence should be controlled through careful system thermal management. Induced birefringence derives from non-uniform expansion of glass by thermal gradients and mismatched material thermal coefficients. The extent to which these thermal effects are seen is related not only to the glass photoelastic constant, but also to absorption, thermal expansion coefficient, and Young's modulus.

MBC PBS can avoid severe thermal stress issues using low index though highly transmissive glass such as SK8. This solution is however not so suitable to broad band, high incident angle MacNeille cubes.

### SUMMARY

The high transmission performance of the birefringent multilayer cube PBS has always been attractive for the shared PBS LCoS projection systems based on ColorSelect® wavelength filters. The stumbling block has always been the severe reflected wavefront distortion. By incorporating a conventional MacNeille-type coating adjacent to a multilayer birefringent stack as part of a hybrid cube approach this challenge can be overcome and allow for high performing, compact projector architectures.

In an embodiment, a polarization beam splitter includes a multilayer birefringent stack adjacent to a dichroic coating, and sandwiched between a first prism and a second prism. The multilayer birefringent stack may include alternate layers of uniaxial polymeric birefringent material, the layers having a common optical axis. The dichroic coating may include alternate layers of high- and low-refractive index materials coated onto the hypotenuse of the second prism. In such an embodiment, the multilayer birefringent stack may be operable to reflect s-polarized light of a first wavelength range, and the dichroic coating may be operable to reflect s-polarized light of a second wavelength range.

According to another aspect, a polarization beam splitter has an optical interface for selectively reflecting and transmitting polarized light. The optical interface includes a multilayer birefringent stack and a dichroic coating adjacent to the multilayer birefringent stack. The multilayer birefringent stack is operable to reflect incident s-polarized light toward a first direction and transmit incident p-polarized light toward a second direction. The dichroic coating is operable to reflect s-polarized light from a fourth direction (parallel but opposite to the second direction) toward a third direction.

According to yet another aspect, a projection system includes a first, second and third PBS. The first PBS has an optical interface including a multilayer birefringent stack and a dichroic coating adjacent to the multilayer birefringent stack. The third PBS is operable to combine light from the first PBS and the second PBS, and operable to output the combined light through an output port.

### BRIEF DESCRIPTION OF THE DRAWINGS

For a more complete understanding of the principles disclosed herein, and the advantages thereof, reference is now made to the following descriptions taken in conjunction with the accompanying drawings in which:

FIG. 1 is a schematic block diagram of a conventional multilayer birefringent cube (MBC) polarization beam splitter (PBS);

FIG. 2 is a schematic block diagram of a stacked birefringent film in accordance with the present disclosure;

FIG. 3A is a schematic block diagram of a conventional MBC PBS that transmits p-polarized light and reflects s-polarized light;

FIG. 3B is a schematic block diagram of another conventional MBC PBS that transmits s-polarized light and reflects p-polarized light;

FIG. 4 is schematic block diagram of a conventional multilayer birefringent cube PBS and Liquid Crystal (LC) modulators for two different wavelength ranges;

FIG. 5 is a schematic block diagram of a PBS in accordance with the present disclosure;

FIG. 6 is schematic block diagram of a modulating subsystem that includes a hybrid PBS and LC modulators for two different wavelength ranges in accordance with the present disclosure; and

FIG. 7 is a schematic block diagram of an exemplary projection system architecture that includes a PBS in accordance with the present disclosure.

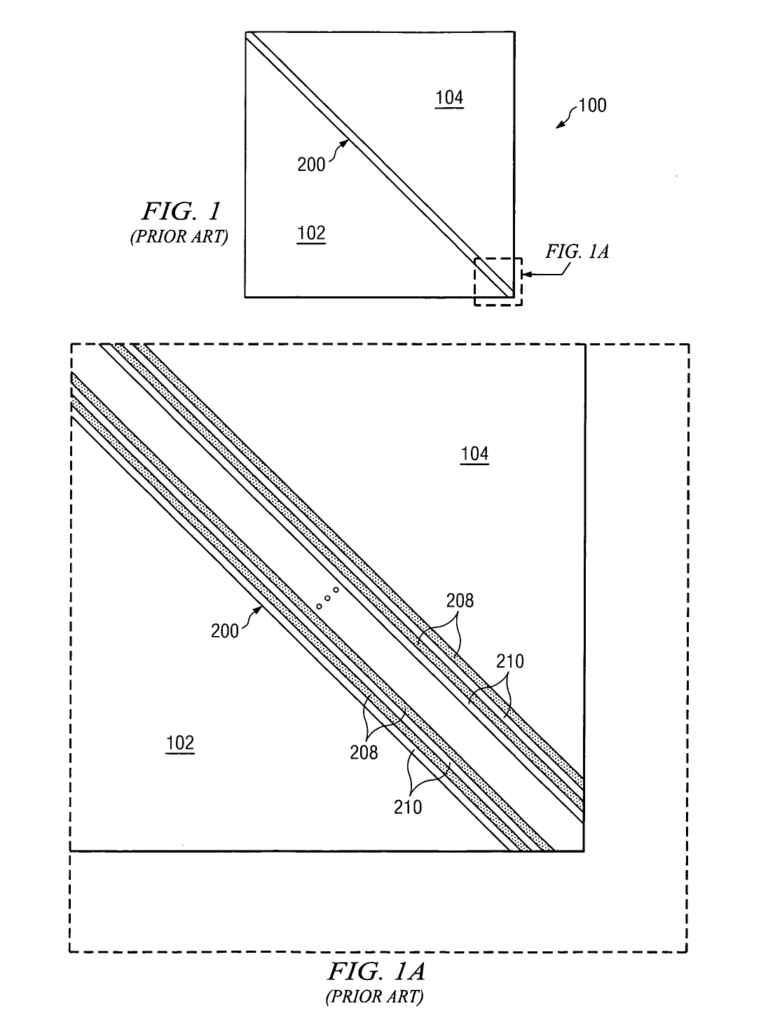

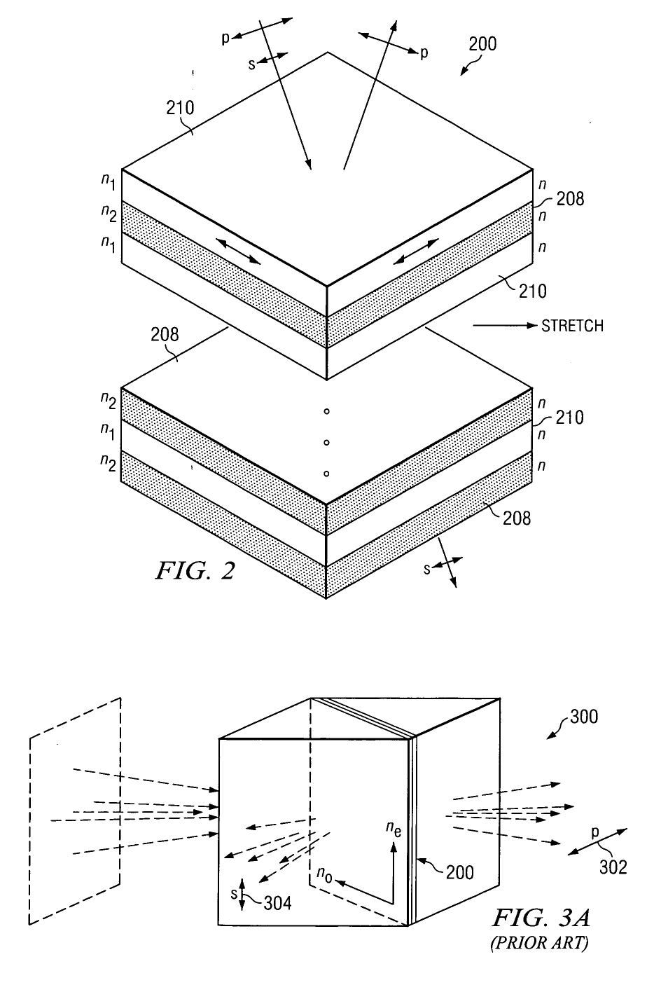

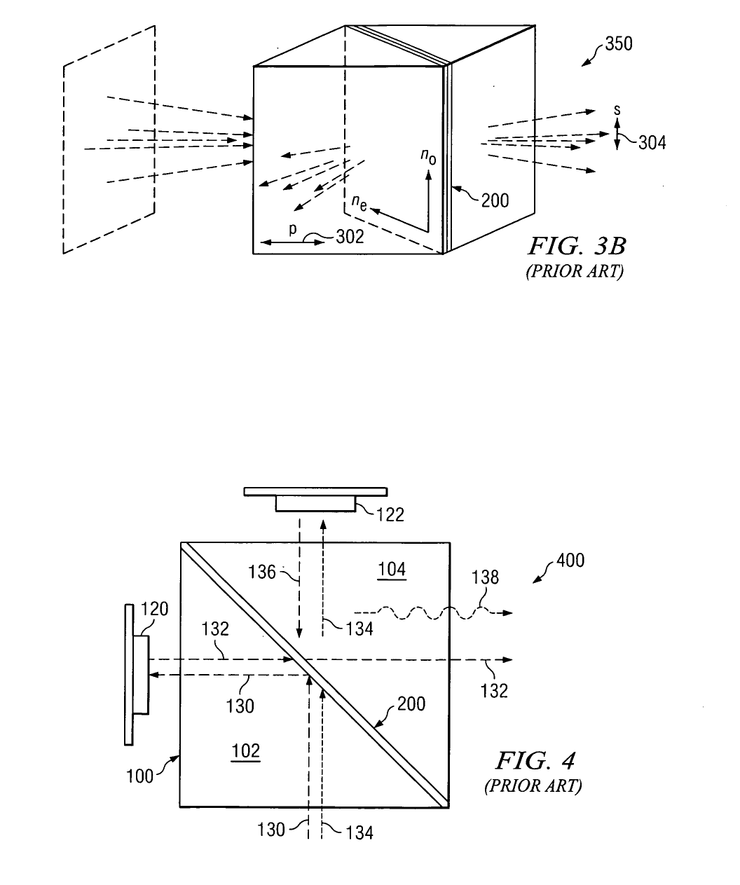

### DETAILED DESCRIPTION

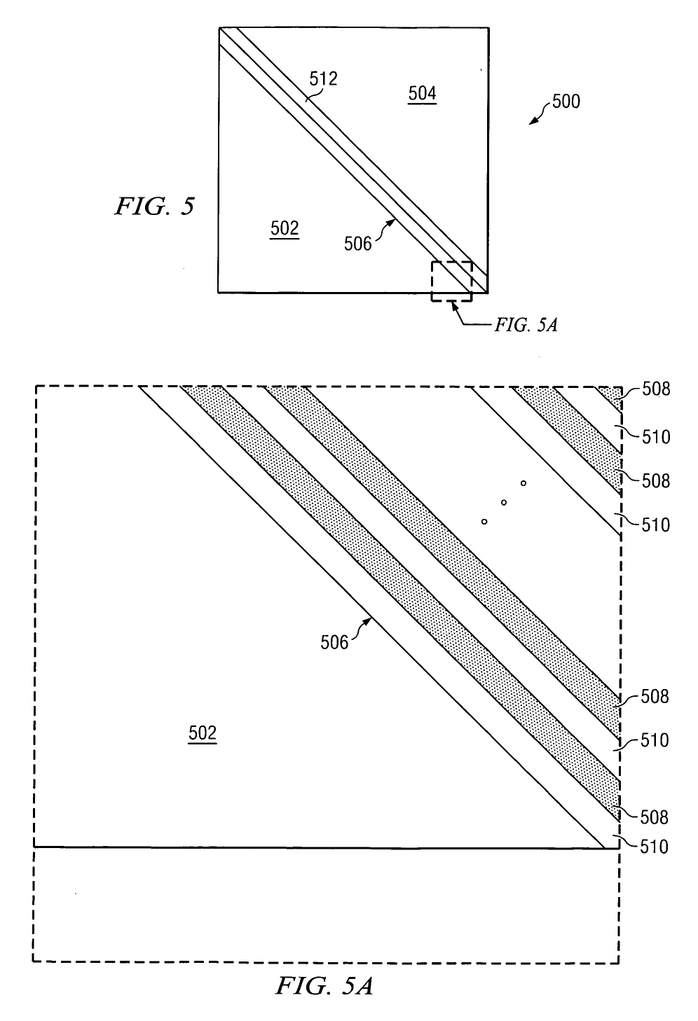

FIG. 5 is a schematic block diagram of a PBS 500 that addresses the above concerns and others. PBS 500 includes a first prism 502 and a second prism 504, a multilayer birefringent stack 506 and a dichroic coating 512, arranged as shown.

The multilayer birefringent stack 506 includes alternating layers of high/low refractive index uniaxial birefringent material, 508 and 510, with a common optic axis. The structure of the multilayer birefringent stack 506 is similar to that described with reference to the multilayer birefringent stack 200 of FIG. 2. The multilayer birefringent stack 506 is sandwiched between first prism 502 and second prism 504, and adjacent to the dichroic coating 512.

The dichroic coating 512 is similar to the dichroic coating used in a MacNeille-type polarizer, in that it comprises alternate layers of high- and low-index materials. The dichroic coating 512 is coated on to the hypotenuse surface of the second prism 504. The dichroic coating material is chosen such that Brewster's angle condition is met at all interfaces, preferably substantially satisfying the Banning relation between refractive indices in accordance with the following equation:

$${n}_{sub}^{2} = \frac{2 {n}_{L}^{2} {n}_{H}^{2}}{{n}_{L}^{2} + {n}_{H}^{2}} \qquad ( equation 1 )$$

where n_{sub} is the refractive index of the glass prisms 502, 504 and adhesive layers (not shown), where n_{L} is the refractive index of the low-index coated material, and where n_{H} is the refractive index of the high-index coated material. For conventional coating materials, this favors high index glass cubes. Furthermore, high index glass helps with maintaining polarization performance over a range of input angles since the incident angles in air are squeezed inside the glass medium.

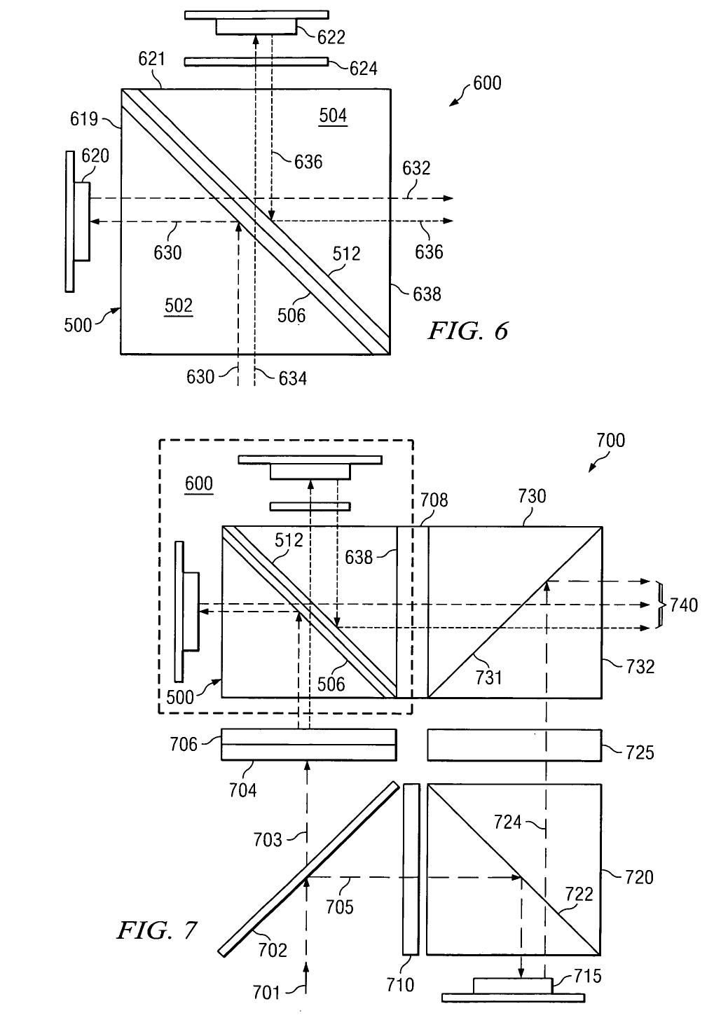

FIG. 6 illustrates a schematic diagram of an exemplary modulation subsystem 600, including PBS 500, a first modulating panel 620, and a second modulating panel 622. Modulating panels 620 and 622 may be of the LCoS variety, although other modulation panels that modulate the state of polarization may alternatively be used. The architecture of modulating subsystem 600 separates two orthogonally polarized wavelength ranges between the two modulator ports 619 and 621. A quarter wave plate 624 may be disposed between modulator port 621 and LC modulation panel 622 to compensate for polarization axis rotation effects from the MacNeille polarizer 512. With reference to embodiments described herein, it is assumed that the LC modulation panels include any further compensation necessary to create a mirror like off-state; and since these compensators are not germane to the present disclosure, they are not illustrated herein.

Both the multilayer birefringent stack 506 and the dichroic coating 512 should be designed to highly transmit p-polarized light (i.e., light 632, 634) of both wavelength ranges, which is desirable for high contrast and transmission. However, the reflection of s-polarized light (i.e., light 630, 636) can be wavelength-range specific, with the multilayer birefringent stack 506 optimized to reflect a first wavelength range (e.g., green); with the dichroic coating 512 optimized to reflect a second wavelength range (e.g., red). In some embodiments, the multilayer birefringent stack 506 and the dichroic coating 512 may act together to suppress s-transmission of the overlapping wavelength range (e.g., yellow), since any multiple reflections between the surfaces of 506 and 512 would, in general, be scattered out of the collection of a projection lens (not shown) and be lost.

Generally, in conventional PBSs, high-index glass such as PBH56 or SF57 has been preferred to achieve good angular performance. In the case of PBS 500, however, the multilayer birefringent stack 506 has a very large field-of-view which would offset any roll-off in the angular performance of a dichroic coating 512. By optimizing the wavelength ranges of the multilayer birefringent stack 506 for a first wavelength range, and the dichroic coating 512 for a second wavelength range, the high-index requirement of the glass prisms 502, 504 may be reduced. This potentially allows for lead-free or low-lead, environmentally friendly glass (e.g., SF6, SF1, SF2, N-BK7, et cetera) to be used for the first prism 502 and the second prism 504, while retaining high performance optical characteristics. Such lower-lead glass is also typically cheaper to produce, leading to mass-production benefits.

In operation, s-polarized light 630 and p-polarized light 634 enters first prism 502. S-polarized light 630 is reflected by the multilayer birefringent stack 506 toward first modulator port 619, at which the first compensated LC modulating panel 620 is disposed. First LC modulating panel 620 modulates the first wavelength range light, which is reflected as p-polarized light 632 back toward the multilayer birefringent stack 506. As p-polarized light 632, both the multilayer birefringent stack 506 and the dichroic coating 512 transmit the first wavelength light toward the output port 638.

Referring now to the path of the p-polarized light 634 entering first prism 502, the light 634 is transmitted by multilayer birefringent stack 506 and dichroic coating 512 toward a second modulator port 621. Located at the second modulator port 621 is a second compensated LCoS panel 622, which may have a quarter wave plate compensator 624 disposed therebetween. In a similar fashion, second LCoS panel 622 modulates a second wavelength range of light 634 and reflects the modulated light 636, which is s-polarized toward the dichroic coating 512. At the dichroic coating 512, the s-polarized light 636 is reflected toward output port 638.

In an exemplary embodiment, the first wavelength range is representative of a green portion of the visible spectrum and the second wavelength range is representative of a red portion of the visible spectrum. In another embodiment, the first wavelength range may be a different color, for example, a blue portion of the visible spectrum and the second wavelength range may be a red portion of the visible spectrum. It should be apparent to a person of ordinary skill that various combinations of wavelength ranges are feasible for other embodiments.

FIG. 7 illustrates an exemplary projection system 700 utilizing projection subsystem 600 of FIG. 6. Projection system 700 includes a first polarization beam splitter 500 that has an optical interface with a multilayer birefringent stack 506 and a dichroic coating 512 adjacent to the multilayer birefringent stack. The projection system 700 also includes a second PBS 720 and a third PBS 730 that is operable to combine light from the first PBS 500 and the second PBS 720, thus, directing light through an output port 732. Generally, projection system 700 shares similarities to the CQ3 Architecture by ColorLink, Inc., of Boulder, Colo.; which is also described in commonly-assigned U.S. Pat. No. 6,961,179, and which is hereby incorporated by reference. In an embodiment, the second PBS 720 may be provided by an MBC PBS, or a MacNeille PBS, although an MBC PBS will likely offer superior performance. Third PBS 730 may be provided by a MacNeille-type PBS, and serves the purpose of combining the first, second, and third wavelength range modulated light. It should be noted that if a MacNeille type polarizer is used for second PBS 720, then a quarter wave plate compensator (not shown) may be disposed between the PBS 720 and third LC modulating panel 715, to compensate for the geometric effects of the MacNeille PBS.

The CQ3 architecture utilizes polarization-based, wavelength-selective, passive spectral filters 706, 708, 725. Such filters may be ColorSelect® filters, which selectively rotate the polarization of one color relative to its complementary, and are available from ColorLink, Inc. in Boulder, Colo. The operation and technical description for ColorSelect® filters is provided in commonly-assigned U.S. Pat. Nos. 5,751,384 and 5,953,083, both of which are hereby incorporated by reference. The projection system 700 also includes a dichroic mirror 702 and wire-grid polarizers 704, 710 as well as third LC modulator 715 for a third wavelength range (e.g., blue). The “90 degree” configuration (shown here), where input light 701 is perpendicular to the output light 740, can be easily modified into a “180 degree” configuration where input light 701 is parallel to the output light 740.

In operation, s-polarized white light 701 enters the projection system 700. At the dichroic mirror 702, light 703, comprising in one embodiment of the red and green color bands, is transmitted toward first PBS 500, while blue light 705 is reflected toward second PBS 720. Referring first to the operation of the first PBS 500, the wire-grid polarizer 704 cleans up the s-polarized light 703. Wavelength-selective filter 706, which may be a red-cyan (RC) ColorSelect® filter, transmits cyan light (which includes green) as s-polarized light, and rotates the state of polarization of red light to an orthogonal state of polarization (p-). Thus, in an embodiment, a first wavelength range is green (falling within the cyan range), which is transmitted as s-polarized light, and a second wavelength range is red, which is transformed to p-polarized light. Accordingly, the operation of modulation subsystem 600 operates in accordance with the description in FIG. 6 such that light at the output port 638 is directed toward a third PBS 730 as well as wavelength-selective filter 708 disposed therebetween. The wavelength-selective filter 708, in this embodiment, may be a magenta/green (MG) wavelength-selective filter that serves to allow a first wavelength range light (i.e., green) to pass as p-polarized light, while rotating the state of polarization of the second wavelength range (i.e., red).

For s-polarized light 705 directed toward the second PBS 720, the wire-grid polarizer cleans up the light 705 such that the s-polarized light reflects off boundary 722 toward a third LC modulating panel 715. Third LC modulating panel 715 modulates a third wavelength range (i.e., blue) and modulated light 724 is p-polarized and directed toward third PBS 730. Wavelength-selective filter 725 may be disposed between second PBS 720 and third PBS 730 to rotate the state of polarization from p- to s-polarized light. Accordingly, third wavelength range (i.e., blue) modulated light reflects at the boundary 731 toward output port 732. The combined modulated light 740 may then be directed toward a projection lens (not shown).

Other embodiments may include variations from the above-described embodiment. For instance, an alternative embodiment may place red and blue LC modulation panels on the output ports of PBS 500, while isolating green modulation port on the second PBS 720. Another embodiment may utilize four LC modulating panels (e.g., for red, green, blue, and yellow wavelength ranges) in accordance with the teachings of commonly-assigned U.S. patent application Ser. No. 11/367,956, entitled “Four Panel Projection System”, which is hereby incorporated by reference. In such an embodiment, modulation subsystems, such as modulation subsystem 600 will be located where the modulation subsystem 600 and the PBS 720 are located. Furthermore, such an embodiment will provide reflective boundaries that are optimized for the respective wavelength ranges of the respective ports. It will be appreciated by those of ordinary skill in the art that the teachings herein can be embodied in other specific forms without departing from the spirit or essential character thereof. The presently disclosed embodiments are therefore considered in all respects to be illustrative and not restrictive. The scope of the invention is indicated by the appended claims rather than the foregoing description, and all changes that come within the meaning and ranges of equivalents thereof are intended to be embraced therein.

Additionally, the section headings herein are provided for consistency with the suggestions under 37 C.F.R. § 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. A polarization beam splitter comprising:
a first prism including a first surface on which light is incident and a second surface that makes an acute angle with the first surface;
a second prism disposed so as to face the second surface of the first prism;
a multilayer birefringent stack adjacent to the second surface of the first prism; and
a dichroic coating between the multilayer birefringent stack and the second prism.

2. A polarization beam splitter according to claim 1, wherein the multilayer birefringent stack comprises alternate layers of uniaxial polymeric birefringent material, the layers having a common optical axis.

3. A polarization beam splitter according to claim 1, wherein the dichroic coating comprises alternate layers of high and low-refractive index materials coated onto a face of the second prism that faces the second surface of the first prism.

4. A polarization beam splitter according to claim 1, wherein the multilayer birefringent stack is operable to reflect s-polarized light of a first wavelength range, and wherein the dichroic coating is operable to reflect s-polarized light of a second wavelength range.

5. The polarization beam splitter of claim 4, wherein the first wavelength range is representative of a green portion of the visible spectrum, and wherein the second wavelength range is representative of a red portion of the visible spectrum.

6. A polarization beam splitter according to claim 4, wherein the first wavelength range is representative of a blue portion of the visible spectrum and wherein the second wavelength range is representative of a red portion of the visible spectrum.

7. A polarization beam splitter according to claim 2, wherein the multilayer birefringent stack is optimized to reflect s-polarized light of a first wavelength range.

8. A polarization beam splitter according to claim 3, wherein the dichroic coating is optimized to reflect s-polarized light of a second wavelength range.

9. A polarization beam splitter according to claim 1, wherein the first prism and the second prism comprise a low-lead content glass.

10. A polarization beam splitter according to claim 9, wherein the low-lead content glass has a photoelastic content of greater than 0.2 nm/cm/10⁵ Pa.

11. A polarization beam splitter according to claim 5, wherein the multilayer birefringent stack and the dichroic coating in combination are operable to suppress s-polarized light in a third wavelength range.

12. A polarization beam splitter according to claim 11, wherein the third wavelength range is representative of a yellow portion of the visible spectrum.

13. A polarization beam splitter (PBS) having an optical interface for selectively reflecting and transmitting polarized light, the optical interface comprising:
a multi layer birefringent stack; and
a dichroic coating adjacent to the multilayer birefringent stack,
wherein the multilayer birefringent stack is operable to reflect incident s-polarized light toward a first direction and transmit incident p-polarized light toward a second direction,
wherein the dichroic coating is operable to reflect s-polarized light toward a third direction.

14. A PBS according to claim 13, further comprising a first glass prism and a second glass prism, wherein the first and second glass prisms sandwich the multilayer birefringent stack and the dichroic coating.

15. A PBS according to claim 14, wherein the first and second glass prisms comprise low-lead content glass.

16. A projection system, comprising:
a first polarization beam splitter (PBS) having an optical interface comprising:
a multilayer birefringent stack, and
a dichroic coating adjacent to the multilayer birefringent stack;
a second PBS; and
a third PBS operable to combine light from the first PBS and the second PBS, and
operable to output the combined light through an output port.

17. A projection system according to claim 16, wherein the multilayer birefringent stack is operable to reflect incident light having a first polarization state toward a first modulating panel, and operable to transmit incident light of a second polarization state toward a second modulating panel,
wherein the first polarization state is orthogonal to the second polarization state,
wherein the dichroic coating is operable to reflect first polarization state light from the second modulating panel toward an output port.

18. A projection system according to claim 16, wherein the second PBS is one of a dichroic PBS and a multilayer birefringent stack PBS.

19. A projection system according to claim 16, wherein the third PBS is a dichroic PBS.

20. A projection system according to claim 17, further comprising:
a third modulating panel located at a port of the second PBS,
wherein the first modulating panel is operable to modulate green light,
wherein the second modulating panel is operable to modulate red light, and wherein the third modulating panel is operable to modulate blue light.
